(19) United States
(12) Patent Application Publication
(10) Pub. No.: US 2025/0371967 A1
(43) Pub. Date: Dec. 4, 2025

(54) PRIORITIZATION SYSTEM FOR ALARMS AND NOTIFICATIONS IN FIRST RESPONDER EQUIPMENT

(71) Applicant: 3M INNOVATIVE PROPERTIES COMPANY, St. Paul, MN (US)

(72) Inventors: Darin K. Thompson, Huntersville, NC (US); Traian Morar, Matthews, NC (US); William B. Howell, Pineville, NC (US); Richard J. Sabacinski, Charlotte, NC (US)

(21) Appl. No.: 18/874,475

(22) PCT Filed: Jun. 28, 2023
(86) PCT No.: PCT/IB2023/056718

§ 371 Date: Dec. 12, 2024

Related U.S. Application Data
(60) Provisional application No. 63/357,139, filed on Jun. 30, 2022.

(51) Int. Cl. G08B 25/00; G08B 25/01

(52) U.S. Cl. CPC G08B 25/006; G08B 25/016

(57) ABSTRACT

A personal protective equipment (PPE) associated with a first responder and including processing circuitry is provided. The processing circuitry is configured to store a prioritization mapping, receive a first alert, determine a first prioritization parameter for the first alert based on the prioritization mapping, determine a user interface modality for the first alert based on the first prioritization parameter, and communicate the first alert to the first responder via the user interface modality.

### TECHNICAL FIELD

This disclosure relates to a method and system for prioritization of alarms and notifications in a first responder equipment user interface.

### INTRODUCTION

The “Fog of War” is a term used to describe the effect of information overload on an individual, such as a first responder, in a dangerous situation. This uncertainty in situational awareness in life-or-death situations is the focus of a great deal of training for emergency first responders, including firefighters.

Personal protective equipment (PPE) is equipment that is used for protection in particular environments such as environments where there is fire, electricity, structural collapse, dangerous temperatures, biohazards, etc. PPE typically includes respirators such as full-face respirators, eye protection, full-face masks, half-face masks, etc. For example, a first responder entering a structure where a fire is present may use PPE such as a full-face respirator coupled to a self-contained breathing apparatus (SCBA) for face protection and to avoid inhaling dangerous gases that result from fires.

In addition to PPE, devices may be used to enhance awareness of the environment. Some of these devices include accessory devices such as locator devices, personal alert safety system (PASS) devices, oxygen level sensors, proximity sensors, navigation devices, etc. Locator devices provide information/data that can be used to locate and/rescue persons such as first responders. Oxygen level sensors allow PPE users to monitor amounts of oxygen left in an SCBA. Proximity sensors allow PPE users to monitor distance to certain objects such as walls that may not be visible in certain low visibility conditions, while navigation devices provide location and directional information which may be useful for finding egress points.

Due to the certification requirements, a typical self-contained breathing apparatus (SCBA) may have multiple “operational” alarms, including, e.g., a PASS device alarm (e.g., indicating an immobilized first responder), a bell/whistle/haptic/visual low air alarms, haptic/audible SCBA failure/fault alarms, visual/text-based notifications, etc. Additional information, such as biometrics of the first responder, may be generated from alarms on hand-held instruments, alarms on area instruments, wearables, etc.

Many of these alarms/alerts may be duplicative of one another, e.g., because regulatory/certification agencies consider such information to be critically important to the user, and often require reiterating the same message/alert according to a standardized protocol. Further, a first responder may receive critical information from several sources and may be forced to frequently look in several directions. Moreover, the use of PPE in conjunction with accessory devices may result in information overload, confusion, unnecessary head and eye movement, disorientation, etc., and ultimately may result in important/critical alerts not being noticed by the first responder.

Thus, existing systems may suffer from oversaturating the first responder user with alarms/alerts, which may impede the first responder's ability to notice and respond to critical alerts, particularly in a dangerous environment.

### SUMMARY

Some embodiments advantageously provide a method, an apparatus, and a system for prioritization of alarms/notifications in a first responder equipment. For example, various algorithms and/or artificial intelligence techniques described herein may be utilized to prioritize alerts/notifications, such as sorting out critical from noncritical information for the user, and determine a modality for providing the information via a user interface.

“Critical information” as used herein may refer to any information which may be relevant to health/safety/security, such as an imminent danger/threat, whereas “noncritical information” as used herein may refer to information which, while relevant, may not be as imminently important to health/safety/security/etc, as critical information. For example, a low air supply alert may constitute critical information, because a first responder's lack of air supply may be an immediately dangerous to life/health/safety/etc, condition. As another example, a “50% battery remaining” notification may constitute noncritical information, because a 50% battery level in a piece of equipment, such as a self-contained breathing apparatus, may be sufficient to provide the first responder with ample time to accomplish an objective and/or exit the dangerous environment. By contrast, a “10% battery remaining” notification may constitute critical information. The particular determination/classification may depend on the equipment involved, the situation/environment, regulations/policies/protocols/standards, the particular first responder/user, etc. Furthermore, although the terms “critical” and “noncritical” may be used herein to classify alerts/notifications in some embodiments of the present disclosure, the classification is not necessarily binary, and may range from “not critical” to “extremely critical.” For example, a scale from 1 to 100 may be used to classify alerts/notifications, where 1 is the lowest level of criticality, and 100 is the highest level of criticality.

According to some embodiments of the present disclosure, the PPE may escalate the alarm according to one or more prioritization algorithms, for example, by flashing one or more heads up display(s), icons, alarms, etc., together to present an unambiguous display/alert to the end user, by overlaying information in visual displays in a first responder equipment, etc. Wired and/or wireless (e.g., radio) communications, such as Bluetooth, low power wide area (LoRA), etc., may be used to transmit data between multiple PPEs, e.g., associated with multiple first responders.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example system including first responder equipment including a PPE and accessory device, according to the principles of the present disclosure;

FIG. 2 shows an example PPE and accessory device, according to the principles of the present disclosure:

FIG. 3 shows an example system including a first responder equipment and a second first responder equipment, according to the principles of the present disclosure:

FIG. 4 shows an example PPE according to the principles of the present disclosure:

FIG. 5 shows another example PPE according to the principles of the present disclosure; and

FIG. 6 shows a flowchart of an example process according to the principles of the present disclosure.

### DETAILED DESCRIPTION

Before describing in detail exemplary embodiments, it is noted that the embodiments reside primarily in combinations of apparatus components and processing steps related to determining a prioritization of alerts and determining user interface modalities for communicating the alerts in a first responder's PPE. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second.” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises.” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term. “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

A “user input” as used herein may refer to any input such as an input provided by a user and may include touch input, input using a force/pressure, voice input, haptic inputs, etc. A feedback action may include any action such as a vibration including bone conduction vibration, an audible action such as an audible output, a display action such as displaying an information element on a display, turning a light on/off, transmitting/receiving a message which may include an information element, establishing/maintaining/terminating communication with another device/unit, display navigation action such as navigating through pages on a display, selecting/creating/moving/deleting/enabling/disabling a symbol/image/data/information on any device/unit, etc.

User interface “modality” as used herein may refer to a mode/method/type of communication between a device (e.g., a user interface of a PPE) and a user of the device (e.g., a first responder wearing the PPE). Modalities include, for example, a visual signal (e.g., a text message/an icon/etc, displayed on a screen or on a region of a screen, a flashing blue light, etc.), an audible signal (e.g., a text-to-speech message, a chime, etc.), a haptic signal (e.g., a vibration configured to be felt by the first responder on the left side of the PPE and/or on the right side of the PPE, etc.), a combination of any of the above, or any other user interface modalities/signals known in the art.

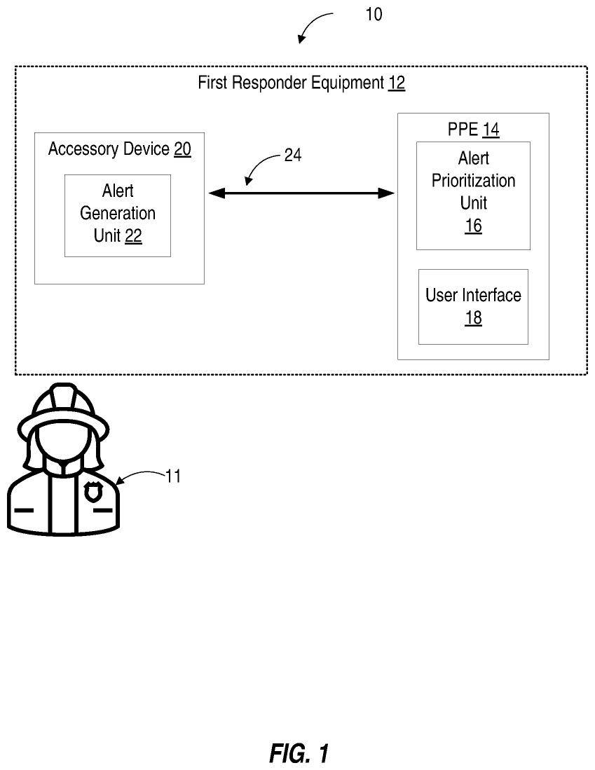

Referring now to the drawing figures, in which like reference designators refer to like elements. FIG. 1 shows an embodiment of a system 10 in which a first responder 11 is associable with (e.g., wears, is equipped with, etc.) first responder equipment 12, which includes a PPE 14 including an alert prioritization unit 16 and a user interface 18. The first responder equipment 12 further includes an accessory device 20, which includes an alert generation unit 22. The accessory device 20 communicates via communication channel 24 with the PPE 14.

Communication channel 24 may be wired and/or wireless, and may include direct communications (e.g., peer-to-peer, device-to-device, near field communications. Bluetooth, universal serial bus (USB). Ethernet, etc.) and/or may include indirect communications (e.g., via a local area network, a mesh network, a wired or wireless connection to a public internet service provider, etc.) between accessory device 20 and PPE 14.

Although first responder equipment 12 is depicted in FIG. 1 as including a single PPE 14 and a single accessory device 20, it is contemplated that multiple accessory devices 20 and/or multiple PPEs 14 may be included in a first responder equipment 12 associated with/associable with first responder 11. For example, a single PPE 14 may receive/detect alerts from three different accessory devices 20a. 20b, and 20c (not shown).

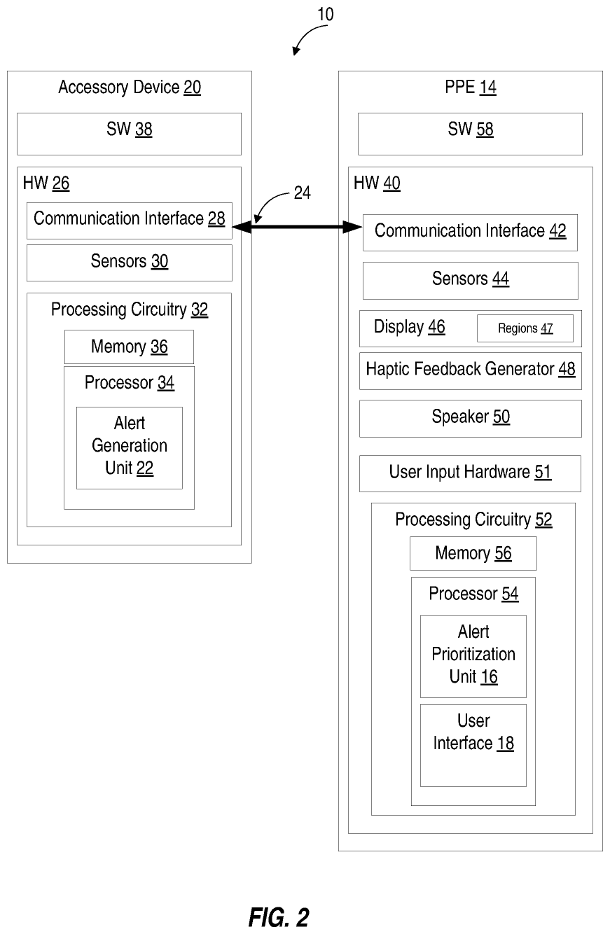

Referring now to FIG. 2, which shows an embodiment of the system 10 shown in FIG. 1, the accessory device 20 includes hardware 26, including communication interface 28, sensors 30, and processing circuitry 32. The processing circuitry 32 may include a processor 34 and a memory 36. In addition to, or instead of a processor, such as a central processing unit, and memory, the processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 34 may be configured to access (e.g., write to and/or read from) the memory 36, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Accessory device 20 may further include software 38 stored internally in, for example, memory 36 or stored in external memory (e.g., database, storage array, network storage device, etc.) accessible by accessory device 20 via an external connection. The software 38 may be executable by the processing circuitry 32. The processing circuitry 32 may be configured to control any of the methods and/or processes described herein and/or to cause such methods, and/or processes to be performed, e.g., by accessory device 20. Processor 34 corresponds to one or more processors 34 for performing accessory device 20 functions described herein. The memory 36 is configured to store data, programmatic software code and/or other information described herein. In some embodiments, the software 38 may include instructions that, when executed by the processor 34 and/or processing circuitry 32, causes the processor 34 and/or processing circuitry 32 to perform the processes described herein with respect to accessory device 20. For example, accessory device 20 may include an alert generation unit 22 configured to perform one or more accessory device 20 functions as described herein, such as generating one or more alerts/notifications/status indicators, e.g., based on sensors 30, to be communicated to the PPE 14, as described herein.

Communication interface 28 of accessory device 20 may include a radio interface configured to set up and maintain a wireless connection (e.g., with PPE 14 via communication channel 24, with other accessory devices 20, with any other component/device of system 10, etc.). The radio interface may be formed as, or may include, for example, one or more radio frequency (RF) transmitters, one or more RF receivers, and/or one or more RF transceivers. In some embodiments, communication interface 28 may be configurable to receive/transmit/forward alert data (e.g., generated/stored by alert generation unit 22) to one or more other accessory device 20. PPE 14, etc. Communication interface 28 may also include a wired interface configured to set up and maintain a wired connection (e.g., with PPE 14, with other accessory devices 20, etc.). The wired interface may include/implement/support one or more wired communication protocols, e.g., USB. Ethernet, etc.

Sensors 30 of accessory device 20 may include one or more devices configured for sensing a condition of accessory device 20, a condition of first responder 11, a condition of first responder 11's environment, for detecting an alert emitted by another accessory device 20 or another PPE 14, or for detecting any other condition/status which may be relevant in a dangerous situation. These sensors 30 may include any number of different types of sensors. Sensors 30 may include (but are not limited to) one or more of motion sensors, ambient light sensors, temperature sensors, gas/chemical/biohazard sensors (e.g., for sensing levels of oxygen, carbon monoxide, toxins, etc.), air pressure sensors, timers, movement sensors, accelerometers (e.g., 3-axis accelerometers), biometric sensors (e.g., for sensing blood oxygen levels, body temperature, pulse, etc, of first responder 11), location sensors, altitude sensors, proximity sensors, image sensors, audio sensors, infrared sensors, eye movement/gaze tracking sensors, and any other sensors/devices used by a first responder 11 and/or part of or in communication with first responder equipment 12, accessory device 20, and/or PPE 14, and any other sensors configurable for tracking, detecting, measuring, etc, a health status and/or condition of first responder 11, first responder 11's environment, and/or first responder equipment 12.

Still referring to FIG. 2, the PPE 14 includes hardware 40, including communication interface 42, sensors 44, display 46 (which may include one or more regions 47), haptic feedback generator 48, speaker 50, user input hardware 51, and processing circuitry 52. The processing circuitry 52 may include a processor 54 and a memory 56. In addition to, or instead of a processor, such as a central processing unit, and memory, the processing circuitry 52 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 54 may be configured to access (e.g., write to and/or read from) the memory 56, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

PPE 14 may further include software 58 stored internally in, for example, memory 56 or stored in external memory (e.g., database, storage array, network storage device, etc.) accessible by first responder equipment 12 and/or PPE 14 via an external connection. The software 58 may be executable by the processing circuitry 52. The processing circuitry 52 may be configured to control any of the methods and/or processes described herein and/or to cause such methods, and/or processes to be performed, e.g., by PPE 14. Processor 54 corresponds to one or more processors 54 for performing PPE 14 functions described herein. The memory 56 is configured to store data, programmatic software code and/or other information described herein. In some embodiments, the software 58 may include instructions that, when executed by the processor 54 and/or processing circuitry 52, causes the processor 54 and/or processing circuitry 52 to perform the processes described herein with respect to PPE 14. For example, PPE 14 may include an alert prioritization unit 16 configured to perform one or more PPE 14 functions as described herein, such as determining a priority and/or user interface modality of one or more alerts/notifications/status indicators, e.g., based on sensors 44, received from accessory device 20, etc., to be communicated to first responder 11 via user interface 18, as described herein.

For example, PPE 14 may include a user interface 18 configured to provide a vibration, including bone conduction vibration, via haptic feedback generator 48, an audible output via speaker 50, a display output, such as displaying an information element on display 46 and/or one or more regions 47 of display 46, turning a light on/off, transmitting/receiving a message which may include an information element, etc.

Communication interface 42 of PPE 14 may include a radio interface configured to set up and maintain a wireless connection (e.g., with accessory device 20 via communication channel 24, with any other component/device of system 10, etc.). The radio interface may be formed as, or may include, for example, one or more radio frequency (RF) transmitters, one or more RF receivers, and/or one or more RF transceivers. In some embodiments, communication interface 42 may be configurable to receive/transmit/forward alert data (e.g., generated/stored by alert generation unit 22) to one or more other PPE 14, accessory device 20, etc. Communication interface 42 may also include a wired interface configured to set up and maintain a wired connection (e.g., with accessory device 20, with other accessory devices 20, etc.). The wired interface may include/implement/support one or more wired communication protocols, e.g., USB. Ethernet, etc.

Sensors 44 of PPE 14 may include one or more devices configured for sensing a condition of PPE 14, a condition of first responder 11, a condition of one or more accessory devices 20 of first responder equipment 12, or any other condition/status which may be of relevance to first responder 11. These sensors 44 may include any number of different types of sensors. Sensors 44 may include (but are not limited to) one or more of motion sensors, ambient light sensors, temperature sensors, gas/chemical sensors (e.g., for sensing levels of oxygen, carbon monoxide, toxins, etc.), air pressure sensors, timers, movement sensors, accelerometers (e.g., 3-axis accelerometers), biometric sensors (e.g., for sensing blood oxygen levels, body temperature, pulse, etc, of first responder 11), location sensors, altitude sensors, proximity sensors, image sensors, audio sensors, infrared sensors, eye movement/gaze tracking sensors, and any other sensors/devices used by a first responder 11 and/or part of or in communication with first responder equipment 12. PPE 14, and/or accessory device 20, and any other sensors configurable for tracking, detecting, measuring, etc, a health status and/or condition of first responder 11, first responder 11's environment, and/or first responder equipment 12.

Display 46 may include one or more screens, which may be integrated in PPE 14. For example, display 46 may be a heads-up display (HUD), in a face mask/goggles of PPE 14. Display 46 may be configured to display one or more alerts, which may include icons, images, text, symbols, data, and/or information. Display 46 may also be configured to display alerts at various regions 47 of one or more screens, such as image on an ocular region, ocular subregion, and/or any other region/location of display 46. Although in FIG. 2 display 46 is depicted as part of PPE 14, in some embodiments, one or more display(s) 46 and/or regions(s) 47 may also/alternatively be located/integrated in accessory device 20.

Haptic feedback generator 48 may include any device, which may be integrated in PPE 14, configured to provide a vibrating or other similar sensation which may be felt/detected by first responder 11. For example, haptic feedback generator 48 may be configured to vibrate according to a certain pattern based on a particular alert type (e.g., a “low air pressure” alert may be associated with a vibration pattern of three pulses per second). Although in FIG. 2 haptic feedback generator 48 is depicted as part of PPE 14, in some embodiments, one or more haptic feedback generator(s) 48 may also/alternatively be located/integrated in accessory device 20.

Speaker 50 may include any device for generating audible alerts/messages. Speaker 50 may include a bone conduction speaker. Although in FIG. 2 speaker 50 is depicted as part of PPE 14, in some embodiments, one or more speaker(s) 50 may also/alternatively be located/integrated in accessory device 20. Further, speaker 50 and haptic feedback generator 48 may be a single device, e.g., where speaker 50 includes a bone conduction speaker configured for generating both audio and haptic feedback.

User input hardware 51 may include any device for receiving user input (e.g., for triggering processing circuitry 52/alert prioritization unit 16/user interface 18/etc.) which may be configured to cause the PPE 14 to perform one or more actions. For example, user input hardware 51 may include one or more buttons, switches, touchscreen inputs, microphones (e.g., for receiving spoken user commands), accelerometer/gyroscope (e.g., for detecting a particular pattern of movements which may be associated with a respective user command), a haptic sensor, a camera such as a camera configured to detect gestures, a sensor such as a proximity sensor, motion sensor, pressure sensor, etc.

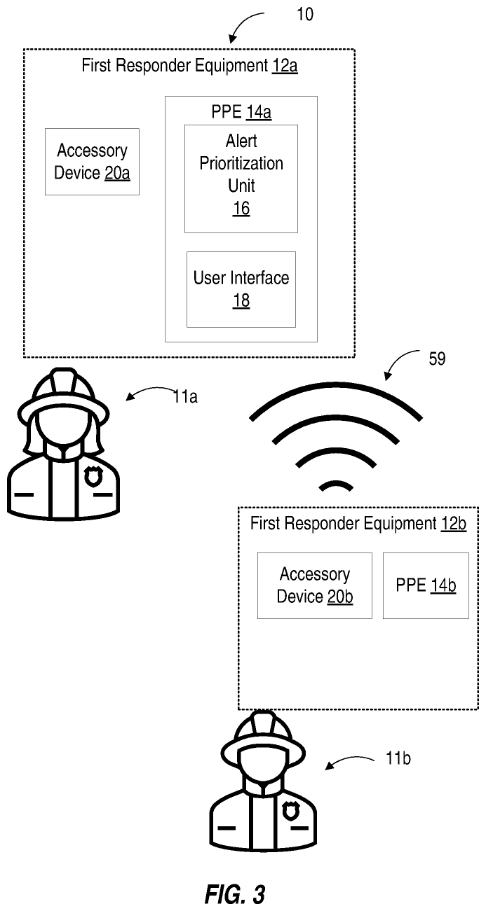

As shown in FIG. 3, in some embodiments, first responder equipment 12a, including PPE 14a, associated with a first responder 11a, may be configured to receive/detect alerts/notifications from other first responder equipment 12b, which may include PPE 14b and/or accessory device 20b associated with a different first responder 11b. For example, PPE 14a worn by a first responder 11a may be configured to detect a signal 59 (e.g., using one or more sensors 44, such as an audio sensor/image sensor/etc., using communication interface 42, etc.), such as an audible alarm, visual indicator (e.g., flashing blue light), and/or radio beacon signal, emitted by first responder equipment 12b (e.g., accessory device 20b. PPE 14b, etc.) worn by/associated with a different first responder 11b. Based on the received/detected signal 59. PPE 14a, such as via processing circuitry 52, alert prioritization unit 16, and/or a mapping stored in memory 56, may be configured to identify/classify the type of device emitting the alarm, the meaning associated with the alarm (e.g., a particular pattern of sounds maps to a respective alarm type), and/or the first responder 11b associated with the first responder equipment 12b emitting signal 59.

Once an alarm/alert has been detected and identified/classified. PPE 14, such as via alert prioritization unit 16, may assign the alarm a priority parameter and, based on the determined priority parameter and/or the identity/classification information associated with the alarm, determine whether and how to communicate the alarm to first responder 11 (i.e., determine a user interface modality for user interface 18). For example, PPE 14 may determine which user interface 18 modalities/functions to utilize for such communication, including determining where (e.g., which region(s) 47) and how (icon, text, etc.) to display the information, whether and how to produce an audible or haptic alert, etc., as described herein.

Embodiments of the present disclosure may be described as modular, e.g., the PPE 14 may include an alert prioritization unit 16 which incorporates/stores/processes data collected from/generated by one or more sensors/accessory devices 20/other PPE 14/etc, and a user interface 18 to convey and prioritize important/critical information. For example, a PPE 14, such as a self-contained breathing apparatus (SCBA), may generate an audible alarm, such as a whistle, to indicate a low air condition. Embodiments of the present disclosure may monitor, e.g., using alert prioritization unit 16, the pressure going to the whistle, such that when the air pressure exceeds a threshold (e.g., an ambient pressure level), the alarm/whistle may sound, and/or a module that listens to the whistle and interprets its pitch may be used to assess remaining air and provide a lowering air alarm, a low air alarm, etc. The alert prioritization unit 16 may assess the criticality according to one or more algorithms disclosed herein, and user interface 18 may provide a visual, audible, and/or haptic alarm/notification to the user, which may override one or more other displays/alerts/communications/etc., as described herein.

In one or more embodiments, the alert prioritization unit 16 may be standalone, part of PPE 14, part of accessory device 20, etc. In another embodiment, the alert prioritization unit 16 is configured to detect (i.e., determine) that one or more accessory devices 20 are connected to the PPE 14 and/or determine one or more alerts/notifications that any of the accessory devices 20 can trigger on the display (or other user interface modality) of the PPE 14. That is, the alert prioritization unit 16 may be configurable to detect what accessory device 20 is connected to the PPE 14, receive alerts/notifications from the accessory devices 20 and/or from the PPE 14, determine a prioritization of one or more of the received alerts/notifications, determine an alert/alarm/notification type/modality/medium for one or more of the received alerts/notification based on the priority, and cause one or more of the PPE 14 and/or accessory devices 20 to communicate the alert(s)/notification(s) to the first responder 11 via one or more user interfaces 18 based on the determined priority and/or the determined alert/notification type/modality/medium. The communication(s) may cause/instruct the displaying of an information element (e.g., symbol/image/text/data/information) on a display 46/region 47 of the PPE 14, triggering an audible and/or haptic alarm (e.g., haptic feedback generator 49 and/or speaker 50), etc.

Although accessory device 20 is depicted in FIG. 1 as part of first responder equipment 12, in some embodiments of the present disclosure, accessory devices 20 may include any third party portable devices, such as smart phones, watches, other wearables or third party stationary devices such as internet of things (IoT) sensors, devices located in a geofenced space, fixed environmental sensors, etc. In other words. PPE 14 may be configurable to detect alerts/alarms/notifications from a wide range of stationary and/or mobile devices without deviating from the scope of the present disclosure.

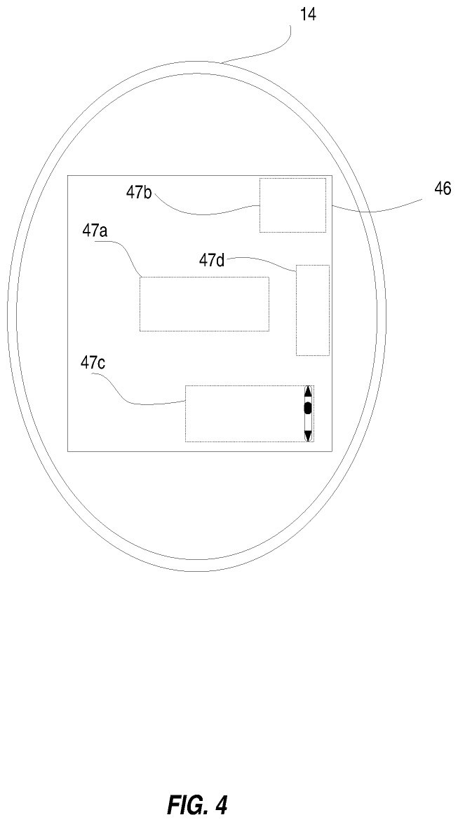

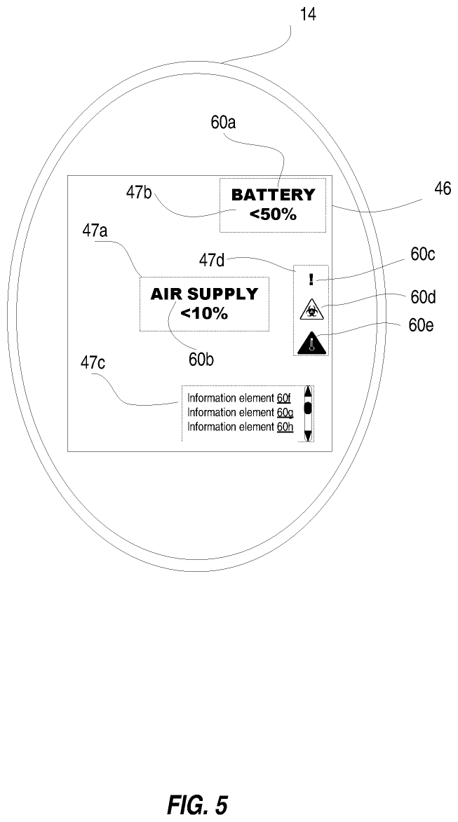

FIG. 4 shows an example PPE 14 according to some embodiments. PPE 14 may include one or more displays 46 including one or more regions 47a-d. As shown in FIG. 5, each region 47 may be configured to display one or more information elements 60a-h associated with the alert/notification/alarm/condition of first responder equipment 12 (including PPE 14, accessory devices 20), of first responder 11, etc. Each information element 60 may be associated with a respective alert (e.g., each alert for which a prioritization parameter is assigned by alert prioritization unit 16), or may be associated with a plurality of alerts (e.g., a group of alerts which are similar, such as a “low air” alert and a “low oxygen” alert). The arrangement of regions 47a-d in FIGS. 4 and 5 is a non-limiting example. It is understood that other arrangements can be used based on design requirements. Similarly, the information shown in FIG. 5 is an example to illustrate the concepts of the disclosure.

An information element 60 as used herein may include text, a symbol, an image, data and/or other information displayable on a screen such as display 46 and/or one or more regions 47 of display 46. Information element 60 may also refer to information conveyed via audio or haptic modalities, e.g., a first information element 60 associated with a low battery alert may include a first pattern of sounds and/or a first pattern of vibrations, while a second information element 60 associated with a low air alert may be include a second pattern of sounds and/or vibrations. Each information element 60 may have at least one characteristic, behavior, shape, color, sound, and/or vibration pattern.

In the non-limiting example depicted in FIG. 5, information element 60a may be a battery status indication located in region 47b at the top-right of the display: information element 60b may be an air supply indication (e.g., indicating an air supply level of first responder equipment 12, such as a SCBA) prominently located in region 47a in the center of display 46: information elements 60c. 60d, and 60e may include symbol alerts such as a Personal Attenuation Rating (PAR) symbol, an error indication, an evacuation indication, a biohazard condition, a temperature status (e.g., ambient temperature is dangerously high), etc., located in region 47d, which may be a panel on the right or left side of display 46: information elements 60f. 60g, and 60h may be lower priority text notifications which are located in a scroll box in region 47c. The information elements 60 and regions 47 depicted in FIGS. 4 and 5 are examples, and other display 46/region 47 layouts and types of information elements 60 may be employed without deviating from the scope of the present disclosure. Further, the particular configuration of regions 47 and information elements 60 in a particular display may be configurable. e.g., by first responder 11.

Further, PPE 14 (e.g., alert prioritization unit 16) may be configured to determine a modality parameter of at least one information element 60. The modality parameter may correspond to a region 47 of display 46, a symbol/text/etc, to be employed for conveying the information element 60, a type of sound to emit (e.g., via speaker 50), a type of haptic feedback to generate (e.g., via haptic feedback generator 48), etc. PPE 14 (e.g., user interface 18) may be further configured to cause the display of the at least one information element 60 based on the determined modality parameter. In a nonlimiting example, a position and a behavior (e.g., symbol visibility) of information element 60 in region 47 of display 46 of PPE 14 is determined (e.g., by alert prioritization unit 16 and/or user interface 18). In another nonlimiting example, the information element 60 is determined/caused to be displayed based on whether the corresponding device/unit e.g., PPE 14, is connected to another device/unit, e.g., accessory device 20. For example, if a connected accessory device 20 includes a display (i.e., a second display in addition to the display 46), an information element 60 associated with a low-priority alert may be displayed on the second display rather than the display 46, whereas if the accessory device 20 is not connected or does not include the second display, then the information element 60 may be displayed on display 46, or may not be displayed at all (e.g., if display 46 is “full” and has no more room for displaying additional information elements 60).

In addition, the information element 60 may be displayed as transparent and/or translucent, i.e., allowing the first responder 11 to at least partially see objects in the environment even when the information element 60 is displayed on an in-mask display 46.

Alert prioritization unit 16 may be configured to determine a prioritization for a plurality of alerts/alarms, e.g., according to a prioritization algorithm, based on an identity of the first responder 11, based on a risk level of first responder 11, based on first responder 11's preferences, based on regulations/policies/etc. (e.g., requiring certain alerts to be displayed regardless of the calculated priority parameter), based on a mapping of alerts/alert types to priority levels, etc., as described herein.

In some embodiments, the priority of a particular alert is determined at least in part based on risk to the first responder 11 associated with the alert. For example, a “low oxygen” alert may be associated with a very high risk to first responder 11, and this may be assigned a relatively higher priority parameter than a “low battery” alert.

In some embodiments, the alert prioritization unit 16 may determine a priority based on an amount of time that the alert has been pending/unresolved. For example, a “no movement detected” alert (which may indicate that the first responder 11 is incapacitated) may initially be assigned a low priority by alert prioritization unit 16, but the priority may be escalated as time passes without the alert being resolved.

As used herein, “resolved,” as in an alert being “resolved,” may refer to a cessation of the condition which caused the alert to be generated. For example, a “low air” alert may be resolved when the first responder 11 refills the air tanks in first responder equipment 12. “Resolved” may also refer to a first responder 11 dismissing an alert, e.g., via user input hardware 51. For example, a “software update ready” alert may be resolved when the first responder 11 updates SW 58, or may be resolved (or temporarily resolved) when first responder 11 presses a button (via user input hardware 51) to dismiss the alert (i.e., dismiss the information element 60 corresponding to the alert, causing it to disappear from display 46). Some alerts, such as alerts which are assigned (e.g., by alert prioritization unit 16) a priority above a particular threshold and/or alerts which are characterized as non-dismissible, may not be dismissed/resolved by first responder 11/user input hardware 51, and may only be resolved when the condition which triggered the alarm is resolved (e.g., for a “low air” alert, when the air tanks are refilled). Alternatively, some alerts/information elements 60 may be not be dismissible by first responder 11, but may be assigned a lower priority and/or assigned a different region 47 and/or modality of user interface 18 based on the first responder 11 attempting to dismiss the alert. For example, the information element 60 associated with a “low air” alert may be moved from a centrally-located region 47a to a peripherally-located region 47c based on the first responder 11 input (e.g., via user input hardware 51).

The determination by alert prioritization unit 16 of which modalities of user interface 18 to display an alert, what types of information elements 60 to use for communicating an alert, etc., may be based at least in part on a regulatory/protocol requirement. For example, a regulation (e.g., by a government agency) may require that a particular alert (e.g., “low air”) be displayed regardless of user preferences, other alerts being displayed, elapsed time, etc. Alert prioritization unit 16 may assign a higher priority to such an alert as compared to an alert which is not associated with such regulation, and/or may disregard/override the assigned priority based on such regulation. For example, in an embodiment where priority parameters range from 1 (lowest priority) to 100 (highest priority), the alert prioritization unit 16 may always assign 100 (i.e., the highest value) to a particular alert based on the alert being associated with a regulatory requirement. Alternatively, or additionally, user interface 18 may disregard the determined priority parameter associated with such an alert/information element 60 and/or may override any other alerts/information elements 60 which are not associated with a regulatory requirement.

First responder 11, via user input hardware 51, may “scroll through” the alerts/information elements 60, e.g., using verbal or haptic commands. For example, lower-priority alerts, such as information elements 60f-h (and additional information elements 60 not shown) may be located in a scroll-box region 47c of display 46, and first responder 11 may scroll through the list of information elements 60. In some embodiments, user interface 18 may automatically scroll through information elements 60, e.g., cycling through different information elements 60 every 5 seconds.

A non-limiting example of alert prioritization unit 16 assigning priority parameters to alerts/information elements 60 is as follows. It is to be understood that these values/parameters may be adjusted to reflect operational considerations for fire departments, factories or other organizations, based on regulatory changes, user preferences, etc.

For example, alert prioritization unit 16 may be configured to assign the following alerts (and/or the associated information elements 60) a highest priority/level of alarm, which in some embodiments may be configured to immediately override display 46: Remaining Air Low: Equipment failure imminent: Escalated second highest alarm: Evacuation ordered: SCBA shifts to secondary system; Accelerated air depletion rate (calculated on usage rate during current cylinder, tied to first responder 11 use history, based on neural net/machine learning based on previous incidents, etc.); etc.

Alert prioritization unit 16 may be configured to assign the following alerts a second-highest priority/level of alarm: 50% Air remaining: Biometric critical: Environment critical: Low Battery on communication device: Escalation of third highest alarm; etc. In some embodiments, alert prioritization unit 16 may escalate one or more of these alerts to the highest priority based on an elapsed time associated with the alert (e.g., 5 minutes elapse without the alert being resolved).

Alert prioritization unit 16 may be configured to assign the following alerts a third-highest priority/level of alarm: Biometric alert: Environmental alert: accessory device 20 alarm: Low battery on thermal imaging camera; etc. In some embodiments, alert prioritization unit 16 may escalate one or more of these alerts to the highest or second-highest priority based on an elapsed time associated with the alert (e.g., 4 minutes elapse without the alert being resolved).

As another example, alert prioritization unit 16 may calculate an alert level based on a duration of the alarm/alert/condition and on an escalation factor (e.g., duration of the alarm divided by the escalation factor, where a value of >7 may indicate an interruptive (highest-priority) alarm). An example calculation is as follows:

$$A low air alarm . Alarm level = 10 ( 1 ) = 10.$$

$$50 \% air alarm . 2 minutes into alarm . Alarm level = 5 ( 2 / 2 ) = 5 no alarm$$

$$50 \% air alarm . 3 minutes into alarm . Alarm level = 5 ( 3 / 2 ) = 7.5 alarm$$

$$Biometric alert . 2 minutes into alarm . Alarm level = 3 ( 2 / 4 ) = 1.5 no \\ \\ alarm$$

$$Biometric alert . 4 minutes into alarm . Alarm level = 3 ( 4 / 4 ) = 3 no \\ \\ alarm but escalate due to 4 / 4$$

$$Biometric alert . 6 minutes into alarm . Elevated alarm to 2. Time at \\ \\ alarm level 2 minutes . Alarm level = 5 ( 2 / 2 ) = 5 no alarm .$$

$$Biometric alert . 8 total minutes into alarm . Elevated alarm to 2. Time at alarm level 4 minutes . Alarm level = 5 ( 4 / 2 ) = 10 alarm .$$

$$Other algorithms / calculations may be employed without deviating from the scope of the present disclosure .$$

In at least one aspect of the present disclosure, alerts are provided (e.g., by alert prioritization unit 16) to elicit a response (e.g., from first responder 11). For example, in the context of emergency services, the responses may be broken into three broad categories/tiers, including 1) a ‘highest’ alarm category, in which a desired response may be to immediately exit the incident scene and proceed to a safe area, 2) an ‘attention is required’ alarm category, in which a desired response may be to make first responder 11 aware that there is a situation that can escalate and may merit action by first responder 11 to prevent escalation, and 3) an FYI′ (for-your-information) alarm category, in which a desired response may be to note there is information a person (e.g., first responder 11) should be aware of, but which may not merit immediate action. Although this particular example includes three broad categories, it is to be understood that other alarm/alert categorization/prioritization schemes may be used without deviating from the scope of the present disclosure, including the use of different category labels, the use of fewer or more than three categories, the use of subcategories, etc.

The first tier or ‘highest’ alarm category may include, for example, one or more of the following alarm types: evacuation notice from command, end-of-service-time indicator (EOSTI), red level physiology sensor, other PPE 14 fail alarm, escalation from one level down alarm, other alarm from command. “where am I compass” alarm, red level environmental alarm, respirator failure alarm, etc. The respirator failure alarm may include, for example, second stage reducer engaged, lens integrity fail, mask seal fail, low air alarm, purge valve left open, etc. The mask seal failure may be indicated, for example, by combustion products detected in the mask or high or low temperature detected in the mask, etc. Red level physiology sensor alarm may be an indication of high core temperature, low blood oxygen, persistent coughing, fixed gaze, other biometrics, etc., associated with first responder 11, e.g., as detected by sensors 44. ‘Other alarm from command’ may be an indication of other commands received from a crew lead, safety officer, incident commander, etc., or may be an indication of a PASS alarm from another first responder 11.

The second tier or “attention is required” alarm category may include, for example, escalation of an alarm from one level down, low air alarm, low battery on PASS or other electronics, environmental sensor alarms, etc. The environmental sensor alarms may include, for example, ambient temperature, gas or vapor, sound identification (for example, the sound of a whistling increasing in pitch may be an indication of a gas leak getting worse), radiant heat, proximity to geofenced area, other site specific (for example, an indication of hazardous materials on site) state, etc., which may be detected by one or more sensors 44. Gas or vapor alarm may be triggered, for example, by an exposure limit, rate of change (derivative rate of change rapidly increasing or rapidly changing short term high level followed by a trough-passing through a gas cloud), etc., as detected by one or more sensors 44.

The third tier or for-your-information (FYI) alarm category may include, for example, an indication that someone else's PASS alarm is sounding (e.g., another first responder 11 in the vicinity of the first responder 11), the first responder 11 user's first/initial low air alarm, the first responder 11 user's PASS pre-alert alarm or a physiology sensor FYI alert (for example, persisting increases in body core temperature or heart rate, as detected by one or more sensors 44), etc.

In addition to the relative urgency of the alarm, the timing, sequence, persistence of the alarm may all be critical information in the decision process (e.g., by alert prioritization unit 16 and/or first responder 11) for the appropriate immediate response in the face of critical priorities.

An example scenario according to some embodiments of the present disclosure includes a first responder 11 (e.g., a firefighter) in a burning building searching for people lost or injured. Depending on the immediate circumstance, the first responder 11 may reprioritize the alarms in his mind. The risk of first responder 11 losing track of an alarm or a group of lesser alarms that are pointing to a greater hazard may need to be considered (e.g., by alert prioritization unit 16) in implementing some embodiments of the present disclosure.

In some embodiments of the present disclosure, the alert prioritization techniques/algorithms (e.g., as implemented by alert prioritization unit 16) may work in concert with a display 46. The display 46 may show the highest risk alarm to the first responder 11 user. The most obvious is an alarm from the highest alarm category, for example, low air.

However, the alert prioritization algorithm (e.g., as implemented by alert prioritization unit 16) may also be monitoring (e.g., via one or more sensors 44) the time since air-on and key levels (e.g., half full, one third full, one quarter full, etc.) and/or air usage. A disparity between the air usage rate and time to key levels may indicate that there is a leak in the system that merits the highest alarm. A lower level alarm might normally sound if the first responder 11's air usage is higher than normal, but an alert would be sent to the command center noting that there may be a physiological problem or latent emergency associated with the first responder 11.

In some embodiments of the present disclosure, alert prioritization unit 16 may be configured for handling/prioritization of concurrent, escalating, and/or de-escalating alarms. The highest tier alarm going off may be an indication for the first responder 11 user to be exiting the area. Another alarm going off may not elicit a greater response than immediate evacuation. Another highest tier alarm or even attention required or FYI alarms may not change the evacuation response, and so they may be suppressed (e.g., by alert prioritization unit 16).

However, there may be important/relevant information (i.e., for first responder 11) to be obtained from the alarms, their sequencing, and/or resolution. The information may be helpful in deciding (e.g., by alert prioritization unit 16) escalation or de-escalation of multiple alarms and later analysis of an incident. One or more prioritization algorithms/configurations may be utilized for such decision-making (e.g., by alert prioritization unit 16). There also may be preferences customized by an administrator of first responder equipment 12 (e.g., an individual fire department operations), which may be considered (e.g., by alert prioritization unit 16) in determining/adjusting the sequencing and prioritization of alarms. Depending on the type of incident and/or response, there may be different priorities assigned (e.g., by alert prioritization unit 16), and individual modifications (e.g., due to medical conditions of first responder 11) may be implemented.

An example of the progression of alarms according to one or more embodiments of the present disclosure is SCBA air depletion. For example, an FYI alarm may be displayed (e.g., by display 46) when the SCBA is at 50% (e.g., as determined by alert prioritization unit 16). An ‘attention required’ alarm may display at 33% remaining capacity (e.g., as determined by alert prioritization unit 16). Highest alarm may show at 25% remaining capacity (e.g., as determined by alert prioritization unit 16). At that time, the first responder 11 user may be expected to egress the incident scene. Another overlaying analysis may include determining (e.g., by alert prioritization unit 16) “what is the rate of depletion of air”, and assigning an appropriate alarm/prioritization accordingly. Air depletion of 400 liters-per-minute (LPM) for a few seconds may merit an attention alarm. 400 LPM depletion over 10 seconds may merit a high level alarm (depending, e.g., on the capacity of the air cylinder). Pressure/air depletion may be determined, for example, using the application of an ideal gas law, the specifics of which are beyond the scope of the present disclosure.

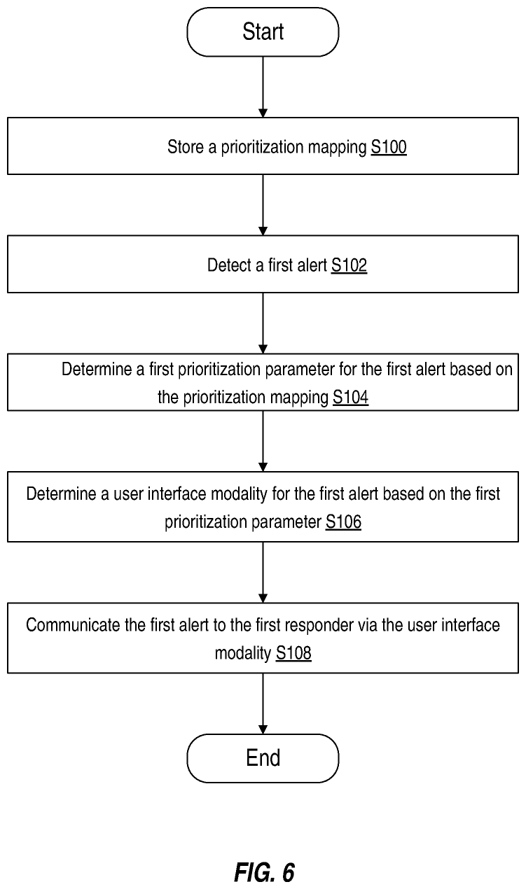

FIG. 6 is a flowchart of an example process in a PPE 14 associated with a first responder 11 according to some embodiments of the invention. One or more blocks described herein may be performed by one or more elements of PPE 14, such as by one or more of hardware 40, communication interface 42, sensors 44, display 46, haptic feedback generator 48, speaker 50, processing circuitry 52, processor 54, memory 56, alert prioritization unit 16, user interface 18, and/or software 58. PPE 14 is configured to store (Block S100) a prioritization mapping. PPE 14 is configured to receive (Block S102) a first alert. PPE 14 is configured to determine (Block S104) a first prioritization parameter for the first alert based on the prioritization mapping. PPE 14 is configured to determine (Block S106) a user interface modality for the first alert based on the first prioritization parameter. PPE 14 is configured to communicate (Block S108) the first alert to the first responder via the user interface modality.

According to one or more embodiments, the PPE 14 includes a display 46 with regions 47, and the determining of the user interface modality for the first alert includes selecting a region 47 of display 46, and communicating the first alert to the first responder 11 via the user interface modality includes displaying the first alert in the selected region 47. According to one or more embodiments, communicating the first alert includes overriding a second alert, the second alert being associated with a second prioritization parameter which is of lower priority than the first prioritization parameter. According to one or more embodiments, the PPE 14 is configured to store a user preference associated with the first responder 11, and the determining of the first prioritization parameter is further based on the user preference. According to one or more embodiments, the PPE 14 is configured to increase the first prioritization parameter based on an elapsed time associated with the alert being above a threshold. According to one or more embodiments, the PPE 14 is further configured to store a set of regulatory policies, the determining of the first prioritization parameter being based on the stored set of regulatory policies.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

1. A personal protective equipment (PPE) associated with a first responder and including processing circuitry configured to:
store a prioritization mapping;
receive a first alert;
determine a first prioritization parameter for the first alert based on the prioritization mapping;
determine a user interface modality for the first alert based on the first prioritization parameter; and
communicate the first alert to the first responder via the user interface modality.

2. The PPE of claim 1, further including a display, the display including a plurality of display regions, the determining of the user interface modality for the first alert including selecting a region of display, and the communicating of the first alert to the first responder via the user interface modality including displaying the first alert in the selected region.

3. The PPE of claim 1, wherein communicating the first alert includes overriding a second alert, the second alert being associated with a second prioritization parameter which is of lower priority than the first prioritization parameter.

4. The PPE of claim 1, wherein the processing circuitry is further configured to store a user preference associated with the first responder, the determining of the first prioritization parameter being further based on the user preference.

5. The PPE of claim 1, wherein the processing circuitry is further configured to increase the first prioritization parameter based on an elapsed time associated with the alert being above a threshold.

6. The PPE of claim 1, wherein the processing circuitry is further configured to store a set of regulatory policies, the determining of the first prioritization parameter being based on the stored set of regulatory policies.
